(19) United States
(12) Patent Application Publication
(10) Pub. No.: US 2009/0059296 A1
(43) Pub. Date: Mar. 5, 2009

(54) IMAGE PROCESSING APPARATUS, FACSIMILE MACHINE, AND COPIER

(75) Inventor: Tetsuya KUWAHARA, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Minami-ku (JP)

(21) Appl. No.: 12/184,349

(22) Filed: Aug. 1, 2008

(30) Foreign Application Priority Data
Aug. 30, 2007 (JP) 2007-224045

(51) Int. Cl. G06F 15/00

(52) U.S. Cl. 358/1.16

(57) ABSTRACT

An image processing apparatus includes an attaching portion to which a portable external storage medium can be removably attached, an output unit arranged to output image information, a writing unit arranged to store set output conditions and an image storage file in which the image information is stored in the external storage medium when the output unit outputs the image information, and a reading unit arranged to read data from the external storage medium. The output conditions and the image storage file stored in the external storage medium attached to the attaching portion can be read by the reading unit, and the image information extracted from the image storage file can be output by the output unit in accordance with the output conditions.

### CROSS-REFERENCE TO RELATED APPLICATION

This application claims priority under 35 U.S.C. 119 to Japanese Patent Application No. 2007-224045, filed on Aug. 30, 2007, which application is hereby incorporated by reference in its entirety.

### BACKGROUND OF THE INVENTION

1. Field of the Invention

The present invention relates to an image processing apparatus and, more specifically, to storing image data in an external storage medium.

2. Description of the Related Art

An image processing apparatus (for example, a facsimile machine and a copier) to which an external storage medium such as a Universal Serial Bus (USB) memory and a memory card can be directly connected is well-known.

In a communication apparatus that can convert an original document image into prescribed image data and transmit the data via a communication line, the conventional art includes the following configuration. That is, the communication apparatus includes an original document scanning unit arranged to scan the original document image and convert the image into the prescribed image data, and an external storage medium attaching portion to which an external storage medium for storing the image data can be removably attached. The communication apparatus further includes a folder name specifying unit arranged to specify a folder name of the external storage medium attached to the external storage medium attaching portion. The communication apparatus also includes a control unit arranged to store the image data in a folder having the folder name specified by the folder name specifying unit.

In the conventional art, facsimile transmission and printing of the image data can be easily performed by having the image data stored in the portable external storage medium and having the medium connected to the apparatus. It is sometimes necessary to output the image data, such as when additional materials are urgently required or retransmission of materials is required due to a communication error or the loss of transmission documents while a user is away from an office on a business trip, for example. Even in such cases, if the user carries the external storage medium in which the image data is stored, the user can retransmit via facsimile or reprint the data at a business trip destination.

However, in facsimile transmission, it is necessary to input a facsimile line number or mail address of a destination, and moreover, it may be necessary to set transmission conditions for confidential transmission, for example. Furthermore, when materials are created by copying, even if the same image data is used, the settings of copying conditions, such as copy magnification, or the settings in which a plurality of pages are aggregated and copied on one page may be performed in accordance with the desired usage of the materials and documents.

In the conventional art, the image data can be stored in the external storage medium, however, the settings of output conditions described above cannot be stored. Accordingly, when performing retransmission via facsimile or additional copying of the materials, it is necessary to perform the settings of conditions again so as to perform output under the same conditions. It is an extremely cumbersome operation to set such conditions each time the transmission and the copying are performed. Therefore, improvements in terms of efficiency of operations are required. Further, there may be many situations in which additional documents and materials are urgently needed, and therefore, a configuration that can perform retransmission via facsimile and recopying in a short period of time has been desired.

### SUMMARY OF THE INVENTION

To overcome the problems described above, preferred embodiments of the present invention provide an image processing apparatus and a method of storing image data in an external storage medium.

According to a first preferred embodiment of the present invention, an image processing apparatus has the following configuration. The image processing apparatus includes an attaching portion to which a portable external storage medium can be removably attached, and an output unit arranged to output image information. The image processing apparatus further includes a writing unit arranged to store, in the external storage medium, set output conditions and an image storage file in which the image information is stored, when the image information is output by the output unit. Moreover, the image processing apparatus also includes a reading unit that can read data from the external storage medium. In the image processing apparatus, the output conditions and the image storage file stored in the external storage medium attached to the attaching portion can be read by the reading unit, and the image information extracted from the image storage file can be output by the output unit in accordance with the output conditions.

According to the first preferred embodiment of the present invention, a user can easily store in the external storage medium the output conditions and the image storage file in which the image information is stored. Accordingly, even when being away from an image processing apparatus that has output the image information, the user can confirm the image information from the contents of the image storage file by connecting the external storage medium that was connected at the time of output to another terminal. Without using the image processing apparatus that has output the image information, the image information can be easily output under the same output conditions as the conditions stored in the external storage medium by having the external storage medium connected to the image processing apparatus of the present preferred embodiment.

In the image processing apparatus, in addition to the image information extracted from the image storage file, additional image information can be preferably output by the output unit in accordance with the output conditions.

According to the first preferred embodiment of the present invention, when the image information is read and output from the image storage file stored in the external storage medium, new image information can be added. Moreover, the same output conditions can be applied to the added image information. Therefore, the cumbersome work of setting the output conditions is eliminated, thereby achieving improved efficiency.

The image processing apparatus preferably includes an operation unit arranged to set the output conditions. In the image processing apparatus, the output conditions read by the reading unit can be changed by the operation unit, and the output unit can output the image information in accordance with the changed output conditions.

According to the first preferred embodiment of the present invention, the output conditions can be flexibly changed, and then the image information can be output. Moreover, since the output conditions can be set by changing the output conditions stored in the external storage medium, the settings can be efficient compared to the initial setting.

In the image processing apparatus, the changed output conditions can be preferably stored in the external storage medium.

According to the first preferred embodiment of the present invention, the changed output conditions can be read by another image processing apparatus, and the image information can be easily output in accordance with the new output conditions.

According to a second preferred embodiment of the present invention, a facsimile machine defining the image processing apparatus includes the following configuration. That is, the output unit corresponds to a facsimile transmitting unit, and the output conditions correspond to transmission conditions. In the facsimile machine, the facsimile transmitting unit transmits the image information via facsimile, and the image information and the transmission conditions can be stored in the external storage medium.

According to the second preferred embodiment of the present invention, when the facsimile transmission is performed, the transmission conditions and the image information can be stored in the external storage medium. Accordingly, by using the portable external storage medium, a transmission image and transmission conditions can be confirmed at a location at which the facsimile machine that has performed the transmission is not available.

According to a third preferred embodiment of the present invention, a copier defining the image processing apparatus includes the following configuration. That is, the output unit corresponds to an image forming unit, and the output conditions correspond to copying conditions. In the copier, the image forming unit prints the image information, and the image information and the copying conditions can be stored in the external storage medium.

According to the third preferred embodiment of the present invention, when the printing is performed, the copying conditions and the image information can be stored in the external storage medium. Accordingly, by using the portable external storage medium, a copy image and copying conditions can be confirmed at a location at which the copier that has performed the copying is not available.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a configuration of a copy-and-facsimile Multi Function Peripheral (MFP) according to a preferred embodiment of the present invention.

FIG. 2 is a flowchart of a process of storing a transmission image and transmission conditions in an external storage medium when facsimile transmission is performed by the MFP according to a preferred embodiment of the present invention.

FIG. 3 is a flowchart of the first half of the process of facsimile retransmission.

FIG. 4 is a flowchart of the last half of the process of the facsimile retransmission.

FIG. 5 is a flowchart of a process of storing an image of an original document to be copied and copying conditions in the external storage medium when copying is performed by the MFP according to a preferred embodiment of the present invention.

FIG. 6 is a flowchart of the first half of the process of recopying.

FIG. 7 is a flowchart of the last half of the process of recopying.

### DETAILED DESCRIPTION OF PREFERRED EMBODIMENTS

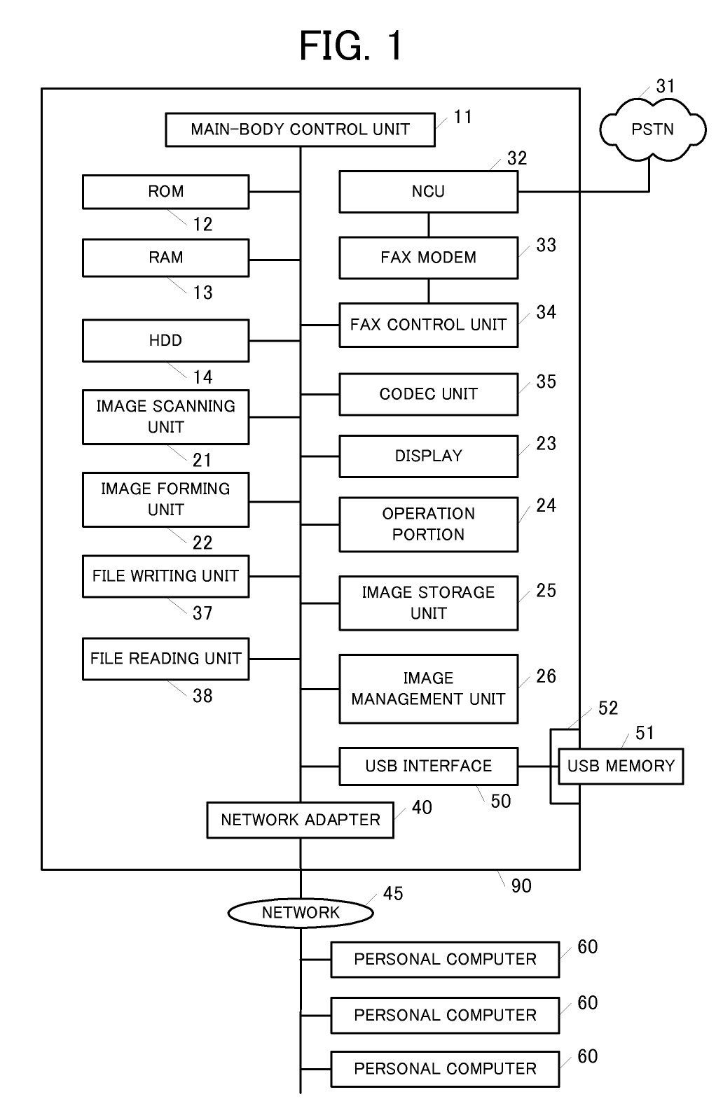

With reference to the drawings, preferred embodiments of the present invention will be described below. FIG. 1 is a block diagram of a copy-and-facsimile MFP according to a preferred embodiment of the present invention.

A copy-and-facsimile MFP 90 defining an image forming apparatus according to the present preferred embodiment includes a facsimile function, a copying function, and a scanner function. As illustrated in FIG. 1, the MFP 90 includes an image scanning unit 21 arranged to acquire image data by scanning an original document, and an image forming unit 22 arranged to record the image data on a recording medium, such as a sheet of paper.

The MFP 90 includes an operation panel (not illustrated) The operation panel includes an operation portion 24 having various keys and buttons, such as a numeric key pad, direction keys, a start button, and a cancellation button.

In the MFP 90, two modes, that is, a facsimile mode and a copy mode can be selected. In the facsimile mode, a facsimile line number or mail address of a transmission destination is specified, and facsimile transmission is performed. In the copy mode, the number of copies to be made is specified, and copying is performed. The mode switching is performed by a user operating the specifying keys and buttons of the operation portion 24.

The user uses the operation portion 24 to perform various settings of the MFP 90. For example, when performing the facsimile transmission using the MFP 90, the user operates the operation portion 24 to switch to the facsimile mode of the MFP 90 and set transmission conditions. The transmission conditions include the transmission destination and the transmission mode.

The transmission destination is information about a destination to which image data is transmitted, and includes the facsimile line number or electronic mail (e-mail) address, for example.

The transmission mode includes various settings of transmission-image-quality conditions indicating image quality conditions, of a transmission report, and of confidential transmission, or other suitable settings. The transmission-image-quality conditions are conditions of resolution of the image data to be transmitted, and include a normal mode and a high image quality mode, for example. The transmission report is the setting of whether or not to output information, such as a communication error, on a sheet of paper by the MFP 90 of a transmission source. The confidential transmission is the setting whether or not to perform the confidential transmission (the transmission having a restriction by which the transmission image data is not output unless a password or security code is input by a facsimile machine at a receiving side).

When performing the copying using the MFP 90, the user operates the operation portion 24 to switch to the copy mode of the MFP 90, and then set copying conditions. The settable copying conditions vary depending on the function of the MFP 90. For example, a printed image quality, selection of the size of papers for printing, enlarged/reduced printing, and aggregation printing (n-page printing) by which a plurality of pages are printed on one sheet of paper, or other suitable copying conditions, may be set.

A display 23 is arranged in the vicinity of the operation portion 24. The display 23 is a liquid crystal display, for example, and can display various pieces of information, such as the content of operations input at the operation portion 24 and a list of facsimile transmission history.

The MFP 90 includes a USB interface 50. The USB interface 50 includes a USB connector 52 as an attaching portion. A USB memory (external storage medium) 51 can be removably attached to the USB connector 52. The USB memory 51 has a compact size so as to be easily carried.

The MFP 90 can read an image storage file stored in the USB memory 51, acquire image data, and perform facsimile transmission or printing on the sheet of paper.

Next, an electrical configuration of the MFP will be described. The MFP 90 includes a main body control unit 11. The main body control unit 11 includes a Central Processing Unit (CPU) that performs control of the overall apparatus.

The MFP 90 includes a Read Only Memory (ROM) 12, a Random Access Memory (RAM) 13, and a Hard Disk Drive (HDD) 14. A program for controlling hardware of each unit of the apparatus is stored in the ROM 12. In the RAM 13, the program stored in the ROM 12 is loaded and executed. The HDD 14 can store various programs and data.

The MFP 90 also includes a file writing unit (writing unit) 37 and a file reading unit (reading unit) 38. The file writing unit 37 can write, when the facsimile transmission is performed, the transmission conditions thereof as a file in the USB memory 51. The file writing unit 37 can write, when the copying is performed, the copying conditions thereof as a file in the USB memory 51. Hereinafter, the transmission conditions and copying conditions will together be referred to as output conditions.

The file writing unit 37 can store the image data scanned by the image scanning unit 21, in the file of a proper format, and write the image storage file in the USB memory 51.

Various file formats may be used when the output conditions are written in the USB memory 51. In the present preferred embodiment, a text file (CSV: Comma Separated Values) in which the contents of various conditions are separated by a comma is used. Moreover, various file formats may be used when the image data is written in the USB memory 51. In the present preferred embodiment, the user can select from among a publicly-known Tagged Image File Format (TIFF), Portable Document Format (PDF), and Joint Photographic Experts Group (JPEG) format.

The file reading unit 38 can read the image storage file stored in the USB memory 51, and also the CSV file in which the output conditions are described. The MFP 90 can perform facsimile transmission and printing on a sheet of paper in accordance with the acquired image data and the output conditions.

The MFP 90 includes an image storage unit 25 arranged to store or temporarily store the image data acquired by the image scanning unit 21, and an image management unit 26 arranged to manage the image data.

The MFP 90 includes a Network Control Unit (NCU) 32 for connecting with a Public Switched Telephone Network (PSTN) 31. The MFP 90 includes a FAX modem 33 arranged as a modulating/demodulating device to mutually convert between a sound signal and a data string. Furthermore, the MFP 90 includes a facsimile control unit 34 arranged to control the NCU 32 and the FAX modem 33, and a codec unit 35 arranged to compress/uncompress the image data. The facsimile function via a telephone line can be implemented by these units. In the codec unit 35, the image data is compressed or uncompressed by using a publicly-known compression format such as a Modified Huffman (MH), Modified Read (MR), and a Modified Modified Read (MMR).

Furthermore, the MFP 90 includes a network adapter (NIC: Network Interface Card) 40 for connecting with a network 45. A Transmission Control Protocol/Internet Protocol (TCP-IP) unit preferably includes the above-mentioned hardware and software that is stored in the HDD 14. Thus, communications with other machines can be performed in accordance with a TCP/IP protocol.

In the MFP 90, a combination of hardware and software defines a Simple Mail Transfer Protocol (SMTP) unit and a Post Office Protocol (POP) unit. The SMTP unit can transmit e-mails by using an SMTP. The POP unit can receive e-mails by using a POP3 protocol.

The MFP 90 of the present preferred embodiment implements an Internet facsimile function by using the SMTP unit and the POP unit. More specifically, the MFP 90 generates an e-mail to which the image data that has been scanned by the image scanning unit 21 and compressed by the compression format such as the MH, MR, and MMR is attached in a proper image format (for example, a TIFF format). Then, the MFP 90 is connected as an SMTP client with an SMTP server (not illustrated) arranged in the network, and can transmit the e-mail. The e-mail may be created in accordance with a publicly-known Multipurpose Internet Mail Extension (MIME) standard and a BASE64 standard, for example.

The MFP 90 operates as a POP3 client, and is connected with a POP server (not illustrated) at prescribed time intervals. When an e-mail to the MFP 90 is received, image data is extracted from the e-mail and uncompressed, and the data can be printed by the image forming unit 22.

As described above, the MFP 90 in the present preferred embodiment can transmit the image data to a destination facsimile machine via the telephone line or an IP network. When the MFP 90 is used to perform the facsimile transmission via the PSTN 31, the FAX modem 33 functions as an output unit. On the other hand, when the MFP 90 is used to perform the Internet facsimile transmission, the SMTP unit functions as the output unit.

Furthermore, the MFP 90 in the present preferred embodiment includes a network printer function. That is, when a printing instruction of a document is received from a personal computer 60 that is connected with the network 45, the MFP 90 properly converts relevant print data and transmits the converted data to the main body control unit 11. Thus, the main body control unit 11 is operated to control the image forming unit 22 and print the document. In this situation, print conditions can be set by operating the personal computer 60.

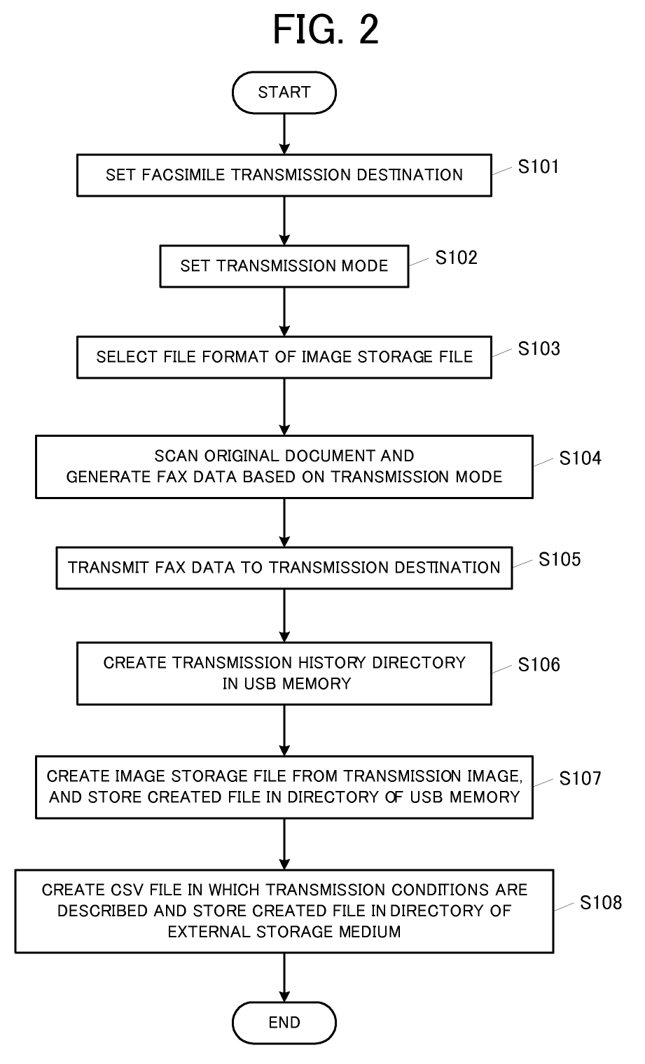

Next, with reference to the flowchart of FIG. 2, a description will be provided of the control performed to store the image data and transmission conditions in the USB memory 51 when an original document is transmitted via facsimile.

When the facsimile transmission that involves image storage in the USB memory 51 is desired, the user operates the operation portion 24 to set the MFP 90 in the facsimile mode under a state in which the USB memory 51 is connected. Then, the MFP 90 waits for the input of a facsimile transmission destination. The user operates the operation portion 24 to input the facsimile line number or mail address of the transmission destination (S101).

Then, the MFP 90 waits for the input of the transmission mode. The user operates the operation portion 24 to perform the setting regarding transmission image quality conditions, transmission report, and confidential transmission (S102).

Next, the MFP 90 inquires about the format of the image storage file that stores the image data. In response to the inquiry, the user operates the operation portion 24 to select the file format from the TIFF format, PDF format, and JPEG format, for example (S103).

When the selection of the file format is completed, the user presses the start button of the operation portion 24. Then, the MFP 90 starts a facsimile transmission process, and scans the content of the original document by using the image scanning unit 21. In accordance with the transmission mode set in S102, the image data is properly converted, and facsimile data is generated (S104). Thus, the facsimile transmission to the transmission destination set in S101 is performed by using the FAX modem 33 (S105).

When the facsimile transmission is completed, the MFP 90 creates in the USB memory 51 a directory under a name that includes, for example, “transmission” and “transmission date and time”, such as “transmission: xx (year), x (month), x (day), xx (hour), xx (minute), xx (second)” (S106). Hereinafter, the directory will be referred to as a transmission history directory. Then, based on the transmitted image data, the image storage file in the file format selected in the process of S103 is created. Further, the image storage file is stored in the directory by the file writing unit 37 (S107).

Then, the transmission conditions set in the process of S101 are stored as a CSV file in the directory by the file writing unit 37 (S108). Thus, the flow is completed.

With the above-described processes, each time the facsimile transmission is performed while the USB memory 51 is connected to the MFP 90, the proper image storage file of TIFF format, PDF format or other suitable format that has stored the transmission image is stored in the USB memory 51. Accordingly, by removing the USB memory 51 from the MFP 90 after the facsimile transmission so as to connect the memory 51 to the personal computer 60 of FIG. 1, for example, and by viewing the stored content of the USB memory 51 by using, for example, an image viewer application, the user can confirm the transmission image. Moreover, by viewing the content of the CSV file by using the personal computer 60, the transmission conditions can be similarly confirmed.

After the setting of the transmission conditions in S101 and S102 in FIG. 2 is completed, whether or not to store the image data and the transmission conditions in the USB memory 51 may be inquired to the user. In response to the inquiry, when the user selects not to store the data and conditions in the USB memory 51, the processes in S103 and S106 through 108 of FIG. 2 are omitted, and only the transmission of facsimile data is performed.

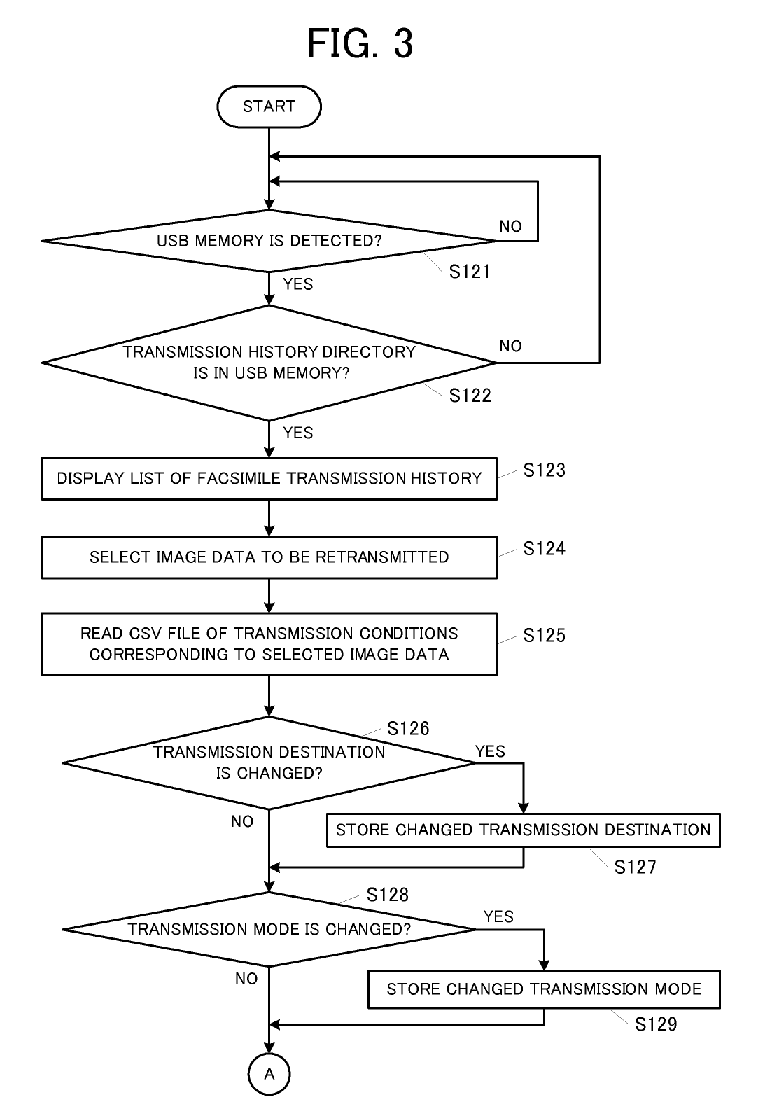

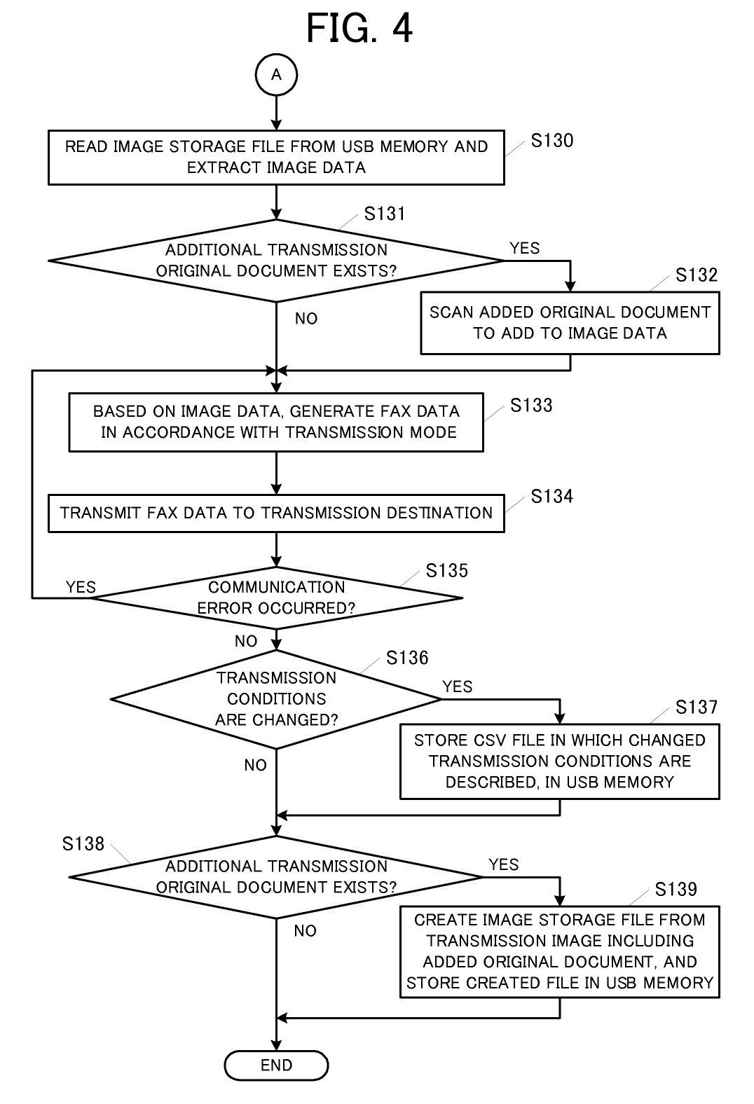

Next, with reference to FIGS. 3 and 4, a process of retransmitting via facsimile the image data stored in the USB memory 51 in the above processes will be described. FIG. 3 is a flowchart illustrating the first half of the process of retransmission performed under a state in which the USB memory 51 with the image data and the transmission conditions stored therein is connected. FIG. 4 is a flowchart illustrating the last half of the process of retransmission.

When the facsimile retransmission is desired, the user connects the USB memory 51 to the MFP 90. The MFP to which the USB memory 51 is connected may be the MFP 90 that has performed the facsimile transmission of FIG. 2, or may be another MFP that includes a similar configuration. The user operates the operation portion 24, sets the MFP 90 in the facsimile mode, and instructs the facsimile retransmission.

Then, the flow in FIGS. 3 and 4 is started in which the MFP 90 first checks whether or not the USB memory 51 is connected (S121 in FIG. 3). When the USB memory 51 is not connected, the MFP 90 waits until the USB memory 51 is connected. At this time, a message prompting the connection of the USB memory 51 may be displayed on the display 23.

When the connection of the USB memory 51 is detected by the determination made in S121, the transmission history directory in the USB memory 51 is searched (S122). If the transmission history directory is not found as a result of the search, a message indicating the result is displayed on the display 23, and the process returns to S121.

When the transmission history directory is found, the MFP 90 creates a list of transmission history based on an analysis result of the file content in the transmission history directory, and displays the list on the display 23 (S123). By operating the operation portion 24, the user can select the image data for retransmission from the list (S124).

When the selection of the image data for retransmission is completed, the MFP 90 reads, by using the file reading unit 38, the CSV file stored as transmission conditions data that corresponds to the selected image data, so as to acquire the transmission conditions (S125).

Then, the MFP 90 inquires whether or not to change the facsimile transmission destination from the original thereof (S126). In response to the inquiry, the user can select whether or not to change the destination. When it is determined in S126 that an operation to change the transmission conditions has been performed, the MFP 90 waits for the input of a new transmission destination. When the user operates the operation portion 24 to input the new transmission destination, the MFP 90 stores the changed transmission destination (S127).

Next, the MFP 90 inquires whether or not to change the facsimile transmission mode from the original thereof (S128). When it is determined in S128 that an operation to change the transmission mode has been performed, the MFP 90 displays the content of the original transmission mode, and waits for the change. The user revises a portion of or the entire transmission mode. When the user instructs that the change has been fixed, the MFP 90 stores the changed transmission mode (S129).

When the above-described setting is completed, the MFP 90 reads from the USB memory 51 the image storage file that corresponds to the transmission history (image data) selected in S124, by using the file reading unit 38, and then extracts the image data from the image storage file (S130 in FIG. 4).

Then, the MFP 90 inquires whether or not there is another original document desired to be added to the previously transmitted documents and to be transmitted (S131). In response to the inquiry, the user can select whether or not to add the document. When the addition of the document is instructed, the MFP 90 scans the added original document by using the image scanning unit 21, and adds the scanned data to the image data acquired in the process of S130 (S132).

Based on the acquired image data, the MFP 90 generates facsimile data in accordance with the transmission mode acquired in the process of S125 or S129 (S133). Then, the MFP 90 transmits the facsimile data via facsimile by using the FAX modem 33 to the transmission destination acquired in the process of S125 or S127 (S134).

Then, the MFP 90 checks whether or not an error has occurred at the time of facsimile transmission (S135). When the transmission has failed due to a communication error, the process returns to S133 where the transmission process is repeated. When the transmission conditions have been changed in the process of S127 or S129, the changed transmission mode and transmission destination stored in the MFP 90 are applied to this transmission retrying process.

When it is determined in S135 that the transmission has been normally performed without any communication error, it is checked whether or not the transmission conditions (transmission destination and transmission mode) have been changed (S136). For example, when the transmission destination has been changed in the process of S127, or when the transmission mode has been changed in the process of S129, a conditions restoring process of S137 is performed. In the conditions restoring process, a CSV file describing the changed transmission conditions is newly created, and by writing the created file over the old CSV file, the overwritten file is stored in the USB memory 51. When the transmission conditions have not been changed, the process of S137 is not performed.

Then, the MFP 90 checks whether or not another original document has been added at the time of facsimile retransmission (S138) When the original document has been added (S132), the image restoring process of S139 is performed. In the restoring process, an image storage file is newly created based on the image data including the data of the added original document, and by writing the created file over the old image storage file, the overwritten file is stored in the USB memory 51. When the document has not been added, the process of S139 is not performed. Then, the flow is ended.

By the above-described flow, the image of the original document for facsimile transmission stored in the USB memory 51 can be easily retransmitted under the same conditions as the conditions used at the time of original transmission.

As described above, the copy-and-facsimile MFP 90 of the present preferred embodiment includes the following configuration. That is, the MFP 90 includes the USB connector 52 to which the portable USB memory 51 can be removably attached, and the FAX modem 33 (or the SMTP unit) arranged to transmit the image data to the facsimile machine at the destination. Moreover, the MFP 90 includes the file writing unit 37 and the file reading unit 38. When the image data is transmitted by the FAX modem 33, the file writing unit 37 stores the CSV file indicating the set transmission conditions in the USB memory 51, and further, stores the image storage file in which the image data is stored, in the USB memory 51 (S101 through S108 of FIG. 2). Then, the MFP 90 reads the CSV file and the image storage file both stored in the USB memory 51, by using the file reading unit 38, and transmits the image data extracted from the image storage file, by using the FAX modem 33 in accordance with the transmission conditions described in the CSV file (S125 of FIG. 3, S130, S133, and S134 of FIG. 4).

With the above-described configuration, the user can easily store the image data along with the transmission conditions in the USB memory 51. Accordingly, when the MFP 90 that has performed the facsimile transmission is not at hand, by having the USB memory 51 connected at the time of transmission connected to the personal computer 60, for example, the transmission conditions and transmission image can be confirmed. Even without the MFP 90 that has performed the facsimile transmission, by having the USB memory 51 connected to another MFP, retransmission can be easily performed via facsimile under the same transmission conditions as the conditions used at the previous transmission.

In addition to the image data extracted from the image storage file, the MFP 90 of the present preferred embodiment can transmit the added image data via the FAX modem 33 in accordance with the transmission conditions (S131 through S134).

With the above-described configuration, at the time of facsimile retransmission, image data can be newly added and retransmitted. Since the same transmission conditions can be used for the added image data, the troublesome setting of the transmission conditions is not required, thereby achieving efficiency.

The MFP 90 of the present preferred embodiment includes the following configuration. That is, the MFP 90 includes the operation portion 24 arranged to set the transmission conditions. The MFP 90 can change, by using the operation portion 24, the transmission conditions read by the file reading unit 38 (S126 through S129 of FIG. 3). Further, the FAX modem 33 can output the image data in accordance with the changed transmission conditions.

With the above-described configuration, the transmission conditions can be flexibly changed to retransmit the image data via facsimile. Furthermore, by starting with the transmission conditions stored in the USB memory 51, and then changing and setting the transmission conditions, the setting can be effective compared with the setting from the start.

The MFP 90 of the present preferred embodiment can store the changed transmission conditions in the USB memory 51 (S137 of FIG. 4).

With the above-described configuration, the changed transmission conditions can be read by the other MFP 90, and the image data can be easily retransmitted under the same conditions.

When using the MFP 90 of the present preferred embodiment as a facsimile machine, the FAX modem 33 functions as the output unit, and the image data is transmitted under the prescribed transmission conditions. The MFP 90 transmits the image data via facsimile by using the FAX modem 33, and also can store the image data and transmission conditions in the USB memory 51.

With the above-described configuration, when the facsimile transmission is performed, the transmission conditions and the image data can be stored in the USB memory 51. Thus, a back-up image of the original document for the facsimile transmission can be easily acquired. Moreover, by using the portable USB memory 51, the transmission image and the transmission conditions can be confirmed at a location where the facsimile machine that actually performed the transmission is not present.

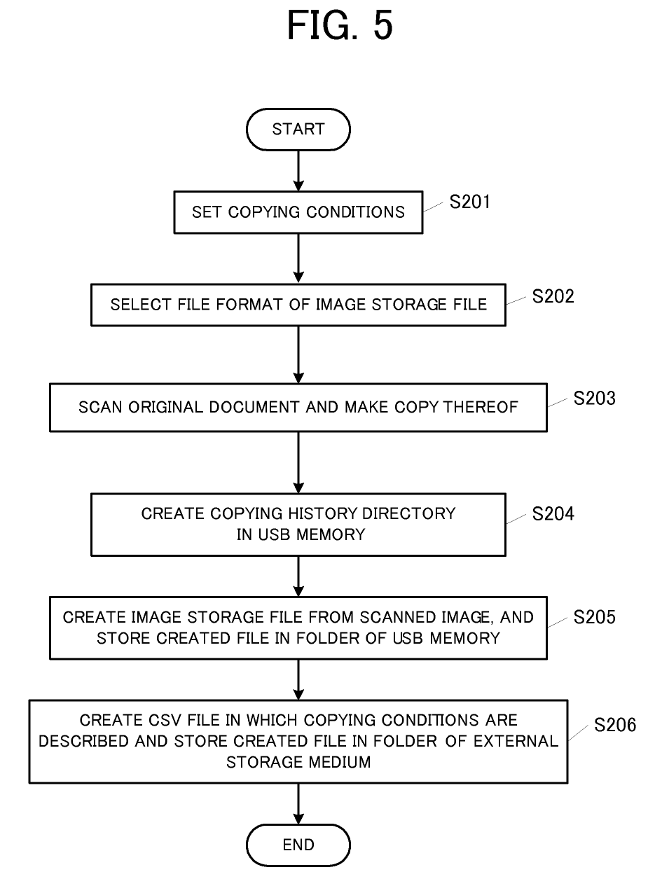

Next, with reference to the flowchart of FIG. 5, a description will be provided of the control by which an image is stored in the USB memory 51 when an original document is copied.

When the user desires copying that involves image storage in the USB memory 51, the user sets the MFP 90 in the copy mode, and inputs the copying conditions from the operation portion 24 (S201). The copying conditions may be, for example, image quality setting, paper size, paper direction, magnification ratio, n-page copying, or other copying conditions. Then, the user selects the file format of the image storage file to be stored in the USB memory 51, from among the TIFF format, PDF format, and JPEG format, for example (S202).

When the selection is completed, the original document is scanned by the image scanning unit 21, print data is generated in accordance with the copying conditions set in S201, and the print data is printed on a sheet of paper by the image forming unit 22. Thus, the copying of the original document is performed (S203).

Then, the MFP 90 creates a directory in the USB memory 51 (S204). The name of the created directory (copying history directory) includes “copying” and “copying date and time”, such as “copying: xx (year), x (month), x (day), xx (hour), xx (minute), xx (second)”. Further, the MFP 90 creates the image storage file in which the scanned image data is stored, and stores the file in the directory of the USB memory 51 (S205). Moreover, the MFP 90 creates a CSV file in which the copying conditions set in S201 are described, and stores the file in the directory (S206).

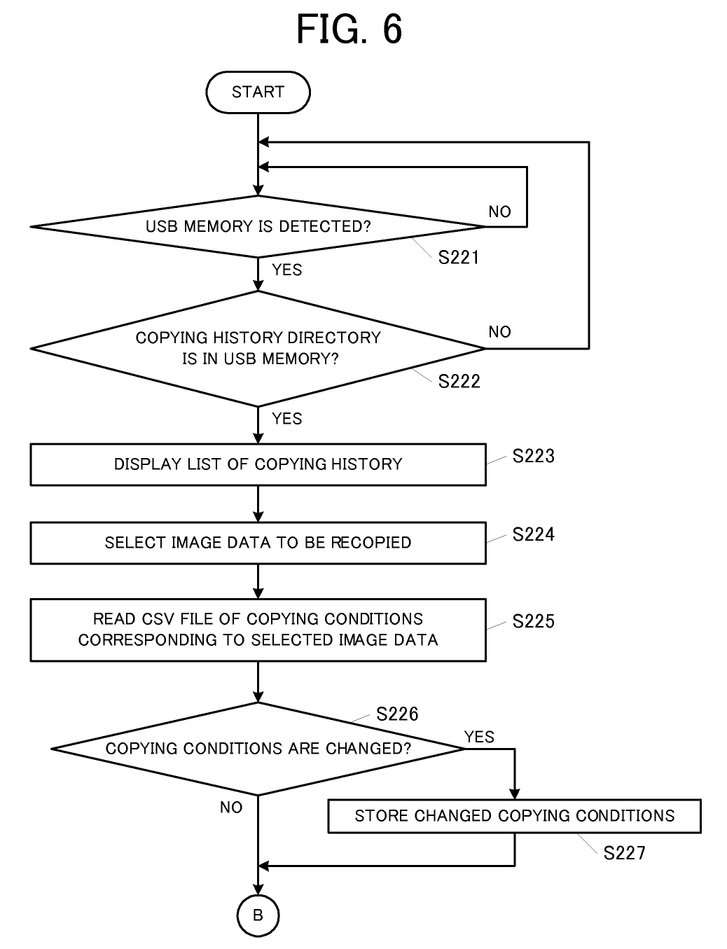

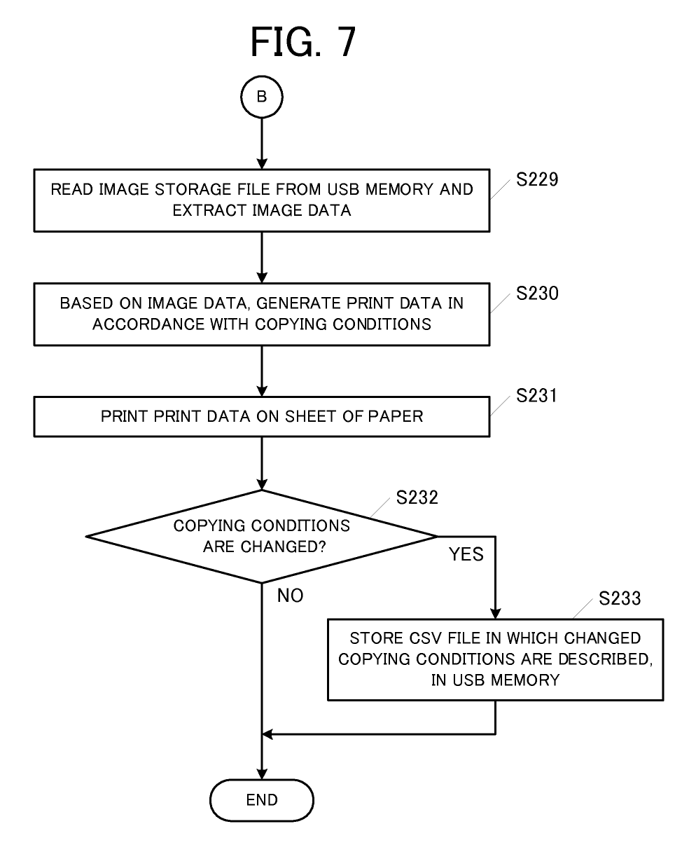

With reference to the flowcharts of FIGS. 6 and 7, reprinting (recopying) of the copied original document will be described. When the user connects the USB memory 51 to the MFP 90 and instructs the reprinting, the MFP 90 checks whether or not the USB memory 51 has been connected, and further, searches the USB memory for the copying history directory (S221 and S222 of FIG. 6).

When the copying history directory is found, the MFP 90 displays a list of copying history on the display 23 (S223). The user properly operates the operation portion 24, and selects from the list the copy history (image data) desired for recopying (S224). Then, the MFP 90 reads the CSV file that corresponds to the selected image data, and acquires the copying conditions (S225).

The MFP 90 inquires the user whether or not to change the copying conditions previously used when the copying was performed (S226). When the user instructs to change the conditions, the copying conditions acquired from the CSV file are displayed on the display 23, and the user changes a portion of the copying conditions that is necessary to be changed. The MFP 90 stores the changed copying conditions (S227).

Next, the MFP 90 reads the image storage file from the USB memory 51, and extracts the image data (S229 of FIG. 7). Then, based on the image data, print data is created in accordance with the copying conditions (the changed copying conditions if the conditions have been changed) acquired from the CSV file (S230). The print data is printed on a sheet of paper by the image forming unit 22 (S231). Thus, the recopying is performed. When the copying conditions have been changed (S227), the CSV file in which the changed copying conditions are described is written over the old CSV file, and then stored in the USB memory 51 (S232, S233).

As described above, when the MFP 90 of the present preferred embodiment is used as a copier, the image forming unit 22 functions as the output unit, and the copying of the original document can be performed under the prescribed copying conditions. Then, the MFP 90 can print the image data of the copied original document by using the image forming unit 22, and also store the image data and the copying conditions in the USB memory 51.

With the above-described configuration, when copying is performed, the copying conditions and the image data can be stored in the USB memory 51. Thus, the backup at the time of copying can be easily performed. Moreover, by using the portable USB memory 51, the image of the copied original document and the copying conditions can be confirmed at a location at which the MFP that actually performed the copying is not present.

A preferred embodiment of the present invention has been described above. However, the above-described configuration can be modified as follows.

In the MFP 90 of the above-described preferred embodiment, the facsimile retransmission and the recopying preferably can be performed by operating the operation portion 24 provided to the MFP 90. However, in place of the above-described configuration, a remote operation from the personal computer 60 may be performed via the network 45. In such a case, the output conditions, such as the transmission conditions and the copying conditions, are set in the personal computer 60, and the output conditions are stored in the USB memory 51 connected to the MFP 90.

In the above-described preferred embodiment, the directory name in the image storage file is preferably set as “transmission: xx (year), x (month), x (day), xx (hour), xx (minute), xx (second)” or “copying: xx (year), x (month), x (day), xx (hour), xx (minute), xx (second)”. However, in place of such names, the name may be the transmission date and time and/or copying date and time only represented as number. Alternatively, a determining method for the directory name may be properly modified such that the directory name can be set by using a proper serial number, or other suitable identification.

In the above-described preferred embodiment, the facsimile mode and the copying process preferably are separately performed. However, in place of such a configuration, the facsimile transmission and the copying may be performed at the same time, and the transmission conditions and the copying conditions may be stored in the USB memory 51.

In the above-described preferred embodiment, the USB memory 51 is preferably used as an external storage medium. However, the medium is not limited to the USB memory 51, and may be changed to a memory card, a removable media (MO), or other suitable storage device.

In the above-described preferred embodiment, when the transmission conditions or the copying conditions are changed, the new CSV file is written over the old CSV file (S137 of FIG. 4 and S233 of FIG. 7). However, in place of such a configuration, both the new CSV file and the old CSV file may be stored by providing a separate file name, and creating a new directory. Similarly, when an original document for facsimile transmission is added (S139 of FIG. 4), the configuration may be modified such that both the old image storage file and the new image storage file are stored.

There may be another case in which only the image storage file is stored in the USB memory 51, and the CSV file of output conditions is not stored. In such a case, the MFP 90 may inquire the user about the output conditions, and perform the facsimile transmission or printing of the image data stored in the USB memory 51, under the input output conditions.

In the above-described preferred embodiment, the operations are preferably performed by using the numeric keypad of the operation portion 24. However, in place of such a configuration, the display 23 may utilize a touch-screen method, and the operations may be performed by using a touch screen.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus comprising:
an attaching portion arranged to removably attach a portable external storage medium thereto;
an output unit arranged to output image information;
a writing unit arranged to store set output conditions and an image storage file in which the image information is stored in the external storage medium when the output unit outputs the image information; and
a reading unit arranged to read data from the external storage medium; wherein
each of the output conditions and the image storage file stored in the external storage medium attached to the attaching portion is read by the reading unit, and the image information extracted from the image storage file is output by the output unit in accordance with the output conditions.

2. The image processing apparatus according to claim 1, wherein in addition to the image information extracted from the image storage file, added image information is output by the output unit in accordance with the output conditions.

3. The image processing apparatus according to claim 2, further comprising:
an operation portion arranged to set the output conditions; wherein
the output conditions read by the reading unit are changed by the operation portion, and the output unit is arranged to output the image information in accordance with the changed output conditions.

4. The image processing apparatus according to claim 3, wherein the changed output conditions are stored in the external storage medium.

5. A facsimile machine comprising:
an attaching portion arranged to removably attach a portable external storage medium thereto;
a facsimile transmitting unit arranged to transmit image information;
a writing unit arranged to store set transmission conditions and an image storage file in which the image information is stored in the external storage medium when the facsimile transmitting unit transmits the image information; and
a reading unit arranged to read data from the external storage medium; wherein
each of the transmission conditions and the image storage file stored in the external storage medium attached to the attaching portion is read by the reading unit, and the image information extracted from the image storage file is transmitted by the facsimile transmitting unit in accordance with the transmission conditions.

6. The facsimile machine according to claim 5, wherein in addition to the image information extracted from the image storage file, added image information is transmitted by the facsimile transmitting unit in accordance with the transmission conditions.

7. The facsimile machine according to claim 6, further comprising:
an operation portion arranged to set the transmission conditions; wherein
the transmission conditions read by the reading unit are changed by the operation portion, and the facsimile transmitting unit is arranged to transmit the image information in accordance with the changed transmission conditions.

8. The facsimile machine according to claim 7, wherein the changed transmission conditions are stored in the external storage medium.

9. A copier comprising:
an attaching portion arranged to attach a portable external storage medium thereto;
an image forming unit arranged to form image information;
a writing unit arranged to store set copying conditions and an image storage file in which the image information is stored in the external storage medium when the image forming unit forms the image information; and
a reading unit arranged to read data from the external storage medium; wherein
each of the copying conditions and the image storage file stored in the external storage medium attached to the attaching portion is read by the reading unit, and the image information extracted from the image storage file is formed into an image by the image forming unit in accordance with the copying conditions.

10. The copier according to claim 9, wherein in addition to the image information extracted from the image storage file, added image information is formed into an image by the image forming unit in accordance with the copying conditions.

11. The copier according to claim 10, further comprising:
an operation portion arranged to set the copying conditions; wherein
the copying conditions read by the reading unit are changed by the operation portion, and the image forming unit is arranged to perform image forming on the image information in accordance with the changed copying conditions.

12. The copier according to claim 11, wherein the changed copying conditions are stored in the external storage medium.
